(19) United States
(12) Patent Application Publication
(10) Pub. No.: US 2019/0207693 A1
(43) Pub. Date: Jul. 4, 2019

(54) PERSONALIZED RADIO SYSTEM AND METHOD OF USE

(71) Applicants: John Mcelhannon, Fort Worth, TX (US); Nikhil C. Jose, Fort Worth, TX (US); Ross Lorberbaum, Fort Worth, TX (US); Tim Groenqvist, Flower Mound, TX (US)

(72) Inventors: John Mcelhannon, Fort Worth, TX (US); Nikhil C. Jose, Fort Worth, TX (US); Ross Lorberbaum, Fort Worth, TX (US); Tim Groenqvist, Flower Mound, TX (US)

(21) Appl. No.: 16/295,807

(22) Filed: Mar. 7, 2019

Related U.S. Application Data
(63) Continuation-in-part of application No. 14/863,547, filed on Sep. 24, 2015, now abandoned.

(51) Int. Cl. H04H 40/09; G11B 20/10

(52) U.S. Cl. CPC H04H 40/09; G11B 2020/10768; G11B 2020/10546; G11B 20/10527

(57) ABSTRACT

A personalized radio system includes a electronic device having a wireless chip and a recorder in communication with a data storage device; the wireless chip to scan for radio waves; a control system to obtain user preferences associated with audio data and utilize algorithms to create key points associated with the user preferences; and a queue of audio recordings accessible via the electronic device; the control system compares the key points associated with user preferences with the metadata of the radio waves to match the key points with one or more digital identifiers of the metadata; the control system facilitates recording of audio data having one or more digital identifiers that match the key points onto the data storage device and into the queue such that the audio data can be played back a single time before being removed from the queue and data storage device.

### BACKGROUND

### 1. Field of the Invention

The present invention relates generally to entertainment systems, and more specifically, to a personalized radio systems for use with an electronic device.

### 2. Description of Related Art

Radio systems are well known in the art and are effective means of public entertainment, particularly during activities such as commuting and traveling. For example, FIG. 1 depicts a conventional radio system 101 having a user 102 in communication with a vehicle stereo system 103 in communication with multiple radio stations 104.

In FIG. 2, a flowchart 201 depicts one example of the process of system 101. The user 102 selects one radio station, which broadcasts appealing entertainment for a while and then begins broadcasting unappealing entertainment, as depicted with boxes 202, 203, and 204. The user 102 then scans for a new radio station until finding another appealing station, as depicted with box 205. The process of scanning and selecting new stations is repeated as necessary each time the user 102 becomes uninterested in the current radio station, as shown with box 206.

One of the problems commonly associated with system 101 is its lack of customization. For example, the user 102 has no control over the timing or content of radio stations and can therefore miss out on desirable entertainment.

In addition, system 101 can cause distraction and risk of danger to the user while traveling in a vehicle.

Accordingly, although great strides have been made in the area of radio systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a common radio system;

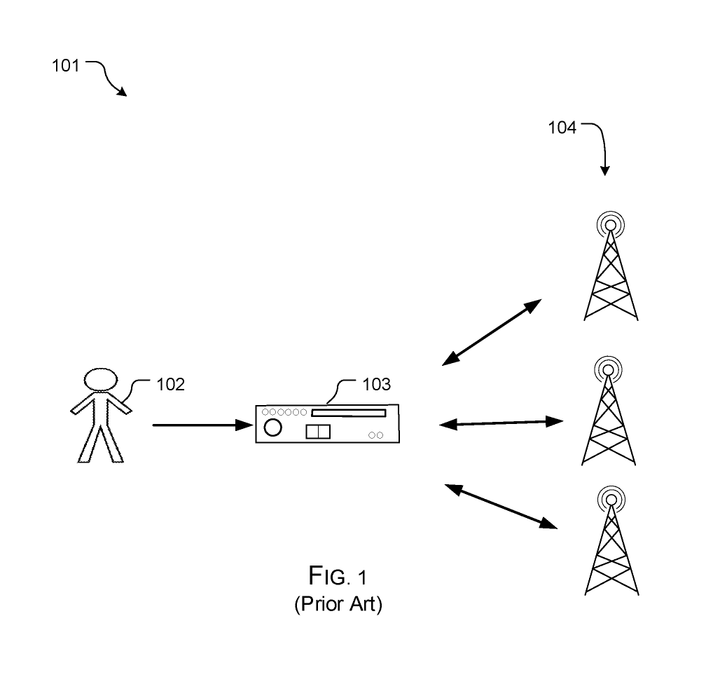

FIG. 2 is a flowchart depicting a process of FIG. 1;

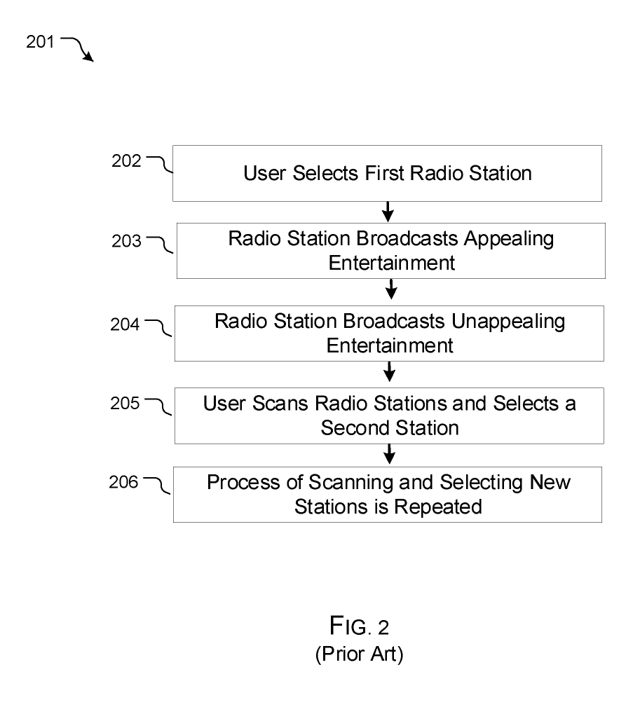

FIG. 3 is a diagram of a personalized radio system in accordance with a preferred embodiment of the present application;

FIG. 4 is detailed schematic of the system of FIG. 3; and

FIG. 5 is a flowchart of the method of use of the system of FIG. 3.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional radio systems. Specifically, the present invention provides a method of user customization. In addition, the present invention decrease the risk of danger associated with using a conventional radio system while driving. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

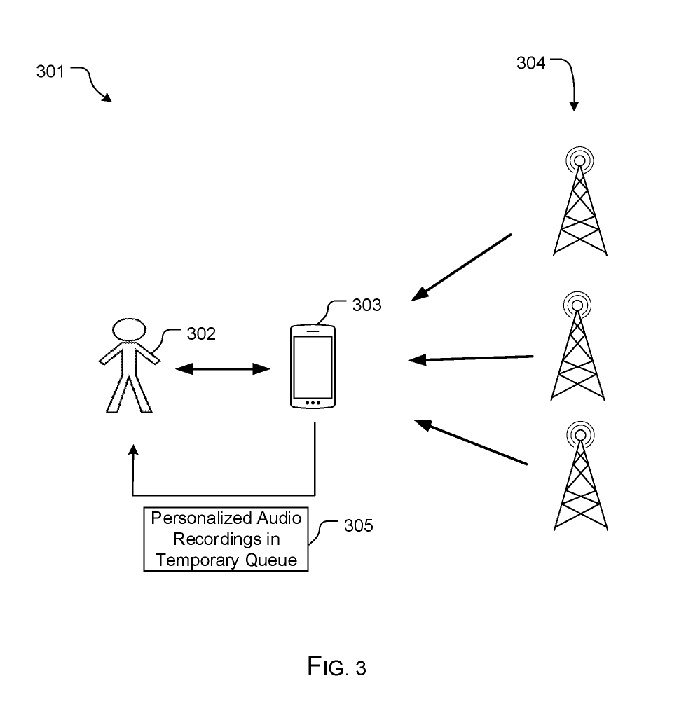

Referring now to the drawings wherein like reference characters identify corresponding or similar elements throughout the several views, FIG. 3 depicts a simplified diagram of a personalized radio system in accordance with a preferred embodiment of the present application. It will be appreciated that system 301 overcomes one or more of the above-listed problems commonly associated with conventional radio systems.

In the contemplated embodiment, system 301 includes a user 302 in communication with an electronic device 303 in communication with multiple radio stations 304 and configured to scan radio waves, including analog and/or digital radio waves. Although a cell phone is shown, it is contemplated and will be appreciated that the electronic device 303 can be any one of a smart phone, tablet, computer, or the like that can communicate wirelessly. As will be discussed herein, the electronic device 303 is configured to determine an audio match based on user preferences and initiate recording of the audio match from the one or more radio stations for later play back, as shown with box 305.

It should be appreciated and understood that the radio stations 304 can be AM stations, FM stations, music stations, talk show stations, or any other mainstream audio stations. The system of the present invention allows for the user to have a continuous, personalized stream of audio from a plurality of location stations.

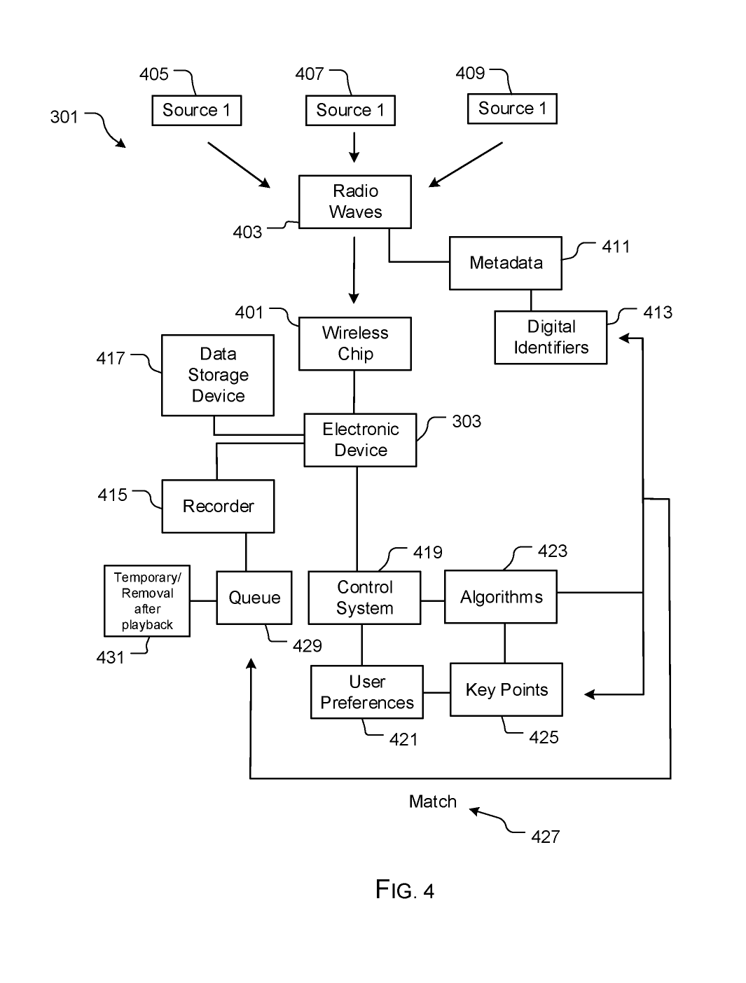

In FIG. 4, a detailed schematic further depicts the features of system 301. System 301 including the electronic device 303 having a wireless chip 401 that is configured to scan and facilitate communication with a plurality of radio waves 403 from one or more sources 405, 407, 409 (radio stations). Wireless chip 401 can be a Bluetooth chip or any similar hardware with FM receiver capabilities and/or analog receiver capabilities. It should be appreciated that the radio waves 403 include metadata 411 that includes details of the audio, such as song title, genre, artist, etc. These details provide digital identifiers 413 that can be utilized by the system to determine if the audio data associated with the metadata is within the user's preferences.

In the preferred embodiment, electronic device 303 further includes a recorder 415 and is in communication with a data storage device 417. It is contemplated that the data storage device 417 can be a local storage device of the electronic device or a remote storage device, such as cloud storage.

System 301 further includes a control system 419 in communication with the electronic device 303. The control system 419 is configured to receive user preferences 421, such as through a mobile application. The user preferences can include likes and dislikes associated with genres, artists, songs, and the like. The control system 419 is configured to work with one or more algorithms 423 to determine key points 425 of the user preferences 421. During use of system 301, the electronic device 303 through the wireless chip 401 scans waves 403 to compare the digital identifiers 413 with the key points 425. Upon the control system, in combination with one or more algorithms, determining a match 427 between the key points and digital identifiers, the control system activates recording of the audio stream into a queue 429 for playback 431.

In the preferred embodiment, the audio data recorded in the queue can be played back once, wherein the audio data will then be removed to free up storage. It is contemplated that the user can skip audio data but cannot rearrange the data within the queue. Therefore, it should be appreciated that the audio data is temporarily stored until either skipped or played by the user, at which point it is removed. It should further be appreciated that the user can established an amount of storage space to be utilized by the system, wherein the system is configured to continuously scan and record until the determined amount of storage space is full, at which time the system will pause until audio data is removed.

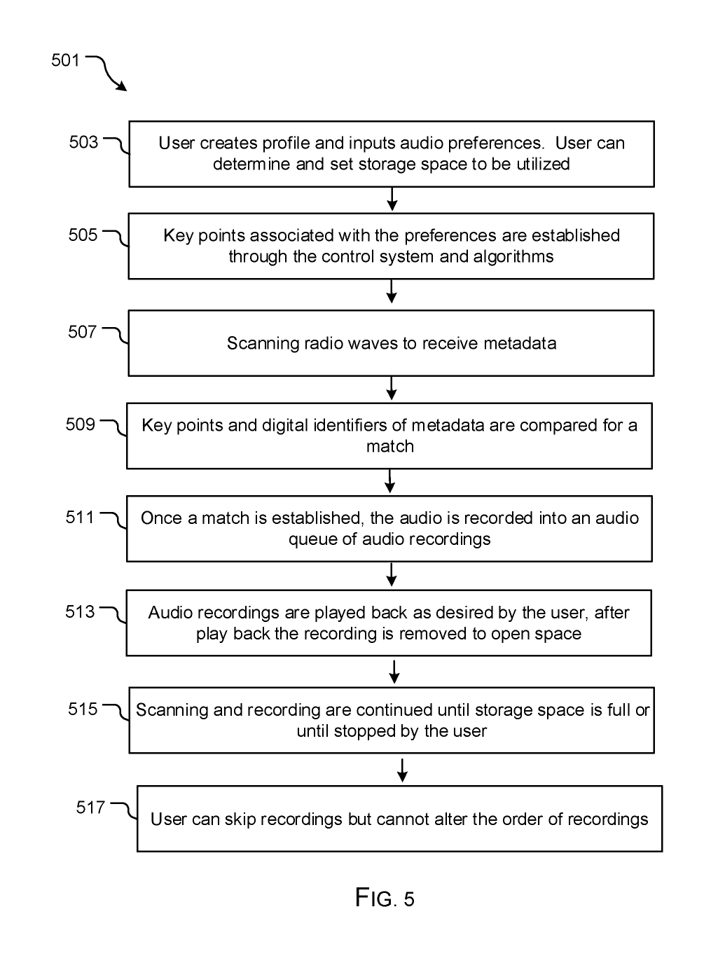

In FIG. 5, a flowchart 501 depicts a method associated with system 301. During use, the user can create a profile and input audio preferences, as shown with box 503. In some embodiments, the user can determine and set storage space to be utilized by the system. Based on the user input preferences, key points associated with the preferences are established through the control system and one or more algorithms, as shown with box 505. The system then proceeds to scan radio waves to receive metadata and compare the digital identifiers of the metadata with the user key points, as shown with boxes 507, 509. Once a match is established, the system begins recording the audio data associated with the match to temporarily save the audio within the user's queue, as shown with box 511. The audio recordings saved within the queue are played back as desired by the user, wherein the audio recordings are removed after being played, as shown with box 513. The system continues to scan and record until the storage space is full or until stopped by the user, as shown with box 515. As desired, the user can skip recordings, however, the user cannot alter the order of the audio recordings, as shown with box 517.

It should be appreciated that one of the unique features believed characteristic of the present application is the temporary storage of audio recordings from one or more radio stations based on user preferences. It is understood that this feature provides greater user control and satisfaction with the radio listening experience by increasing the amount of appealing entertainment available to the user and decreasing the need for scanning radio stations, which can cause distractions during driving.

It is contemplated that system 301 is not limited to music and can be utilized for other radio entertainment such as news and talk shows. An additional feature contemplated is the incorporation of a temporary recording function for pre-scheduled shows, times, and/or days. It is further contemplated that the electronic device application can comprise additional user customization such as duration of playback time and feedback for selected entertainment.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A personalized radio system, comprising:
a electronic device having a wireless chip incorporated therein and a recorder in communication with a data storage device;
the wireless chip to scan for radio waves, the radio waves having metadata associated therewith;
a control system configured to obtain user preferences associated with audio data and utilize one or more algorithms to create a plurality of key points associated with the user preferences; and
a queue of audio recordings accessible via the electronic device;
wherein the control system is in communication with the wireless chip;
wherein the control system compares the plurality of key points associated with user preferences with the metadata of the radio waves to match the plurality of key points with one or more digital identifiers of the metadata;
wherein the control system facilitates recording of audio data having one or more digital identifiers that match the plurality of key points onto the data storage device and into the queue such that the audio data can be played back a single time before being removed from the queue and data storage device.

2. The system of claim 1, wherein the electronic device is a smart phone.

3. The system of claim 1, wherein the data storage device is a local storage device of the electronic device.

4. The system of claim 3, wherein a storage space is set by a user such that once the storage space is filled on the local storage device, the recording of audio data is stopped.

5. The system of claim 1, wherein the control system is configured to allow a user to skip an audio recording.

6. A method of personalized audio playback from recorded radio audio, the method comprising:
providing a electronic device having a wireless chip, a recorder, and a control system incorporated therein;
establishing a plurality of key points associated with user preferences as provided to the control system and analyzed with one or more algorithms;
scanning radio waves with the wireless chip to receive metadata of the radio waves;
analyzing the radio waves to determine one or more digital identifiers of the metadata with the control system and one or more algorithms;
comparing the plurality of key points to the one or more digital identifiers to determine if the radio waves match user preferences;
recording audio associated with the radio waves onto a storage device in communication with the electronic device to create a queue of audio recordings;
playing back the audio recordings of the queue; and
deleting each of the audio recordings of the queue after each of the audio recordings is played back.

7. The method of claim 6, further comprising:
skipping one of the audio recordings based on user command received by the control system.

8. The method of claim 6, further comprising:
establishing a storage space to be filled with the audio recordings based on user preferences.

9. The method of claim 6, further comprising:
preventing the user from altering an order associated with the queue of audio recordings.

10. The method of claim 6, further comprising:
scanning radio waves continuously upon a determination by the control system of available storage space.
